(19) United States
(12) Patent Application Publication
(10) Pub. No.: US 2023/0415591 A1
(43) Pub. Date: Dec. 28, 2023

(54) CHARGING SOCKET FOR MOUNTING IN A BODY OF AN AT LEAST PARTIALLY ELECTRICALLY DRIVEN MOTOR VEHICLE

(71) Applicant: PHOENIX CONTACT E-Mobility GmbH, Schieder-Schwalenberg (DE)

(72) Inventors: Ralf Feldner, Horn-Bad Meinberg (DE); Cedric Deppe, Doerentrup (DE); Carsten Garth, Lemgo (DE)

(21) Appl. No.: 18/253,045

(22) PCT Filed: Nov. 11, 2021
(86) PCT No.: PCT/EP2021/081347

§ 371 Date: May 16, 2023

(30) Foreign Application Priority Data
Nov. 18, 2020 (DE) 102020130410.2

(51) Int. Cl. B60L 53/16; H01R 13/74

(52) U.S. Cl. CPC B60L 53/16; H01R 13/748; H01R 2201/26

(57) ABSTRACT

A charging socket for mounting in a body of an at least partially electrically driven motor vehicle includes: a housing; at least one contact element accommodated in the housing; and at least one fastening region formed on the housing configured to fasten the charging socket to the body of the motor vehicle. The housing includes a metal material at least in regions. The housing includes the metal material at least in a region of the at least one fastening region.

### CROSS-REFERENCE TO PRIOR APPLICATIONS

This application is a U.S. National Phase application under 35 U.S.C. § 371 of International Application No. PCT/EP2021/081347, filed on Nov. 11, 2021, and claims benefit to German Patent Application No. DE 10 2020 130 410.2, filed on Nov. 18, 2020. The International Application was published in German on May 27, 2022 as WO/2022/106293 under PCT Article 21(2).

### FIELD

The invention relates to a charging socket for mounting in a body of an at least partially electrically driven motor vehicle, which has a housing, at least one contact element accommodated in the housing, and at least one fastening region, formed on the housing, for fastening the charging socket to the body of the motor vehicle.

### BACKGROUND

In a mounted state, charging sockets are fixed but detachably installed in the body of an at least partially electrically driven motor vehicle, such as a hybrid motor vehicle or an electric vehicle. The charging socket is connected to a battery inside the vehicle. A charging plug can be plugged into the charging socket in order to charge the battery of the motor vehicle. In the plugged-in state, the at least one contact element of the charging socket is in electrical contact with at least one contact element of the charging plug.

A charging socket has a housing, in particular an outer housing, via which the charging socket is fastened to the body of the motor vehicle. For this purpose, the housing has at least one fastening region, via which the housing is fastened to the body. The housing is usually screwed to the body via its at least one fastening region. The housing of the charging socket is usually entirely formed from a plastic material. If, for example, an impact or the like against a charging plug plugged into the charging socket occurs during a charging process, there is the risk that such large forces act on the charging socket and in particular on the fastening region of the charging socket that damage, in particular breakage of the housing of the charging socket, can occur in the region in which the charging socket is fastened to the body.

### SUMMARY

In an embodiment, the present invention provides a charging socket for mounting in a body of an at least partially electrically driven motor vehicle, comprising: a housing; at least one contact element accommodated in the housing; and at least one fastening region formed on the housing configured to fasten the charging socket to the body of the motor vehicle, wherein the housing comprises a metal material at least in regions, and wherein the housing comprises the metal material at least in a region of the at least one fastening region.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 a schematic representation of a charging socket according to the invention in a perspective view,

FIG. 2 a schematic representation of the charging socket shown in FIG. 1 in a side view,

FIG. 3 a schematic sectional representation of the charging socket along the line A-A drawn in in FIG. 2, and

FIG. 4 a schematic representation of an insert of the charging socket shown in FIGS. 1 to 3.

### DETAILED DESCRIPTION

In an embodiment, the present invention provides a charging socket which is characterized by improved stability so that the risk of damage to the charging socket can be reduced.

The charging socket according to the invention is characterized in that the housing is formed from a metal material at least in regions, wherein the housing is formed from the metal material at least in the region of the at least one fastening region.

By forming the housing from a metal material at least in regions, the stability, in particular the strength against breakage, of the housing can be significantly improved in the regions of the metal material. Damage to the housing when high loads act on the housing from the outside, for example by a plugged-in charging plug, can thereby be avoided or at least reduced. Where the housing is not formed from a metal material, the housing is preferably formed from a plastic material. The housing can thus be formed in the form of a hybrid component having a plastic material and a metal material. The metal material is formed on the housing in particular where the housing has its one or its plurality of fastening regions in order to fasten the housing to the body of the motor vehicle. By forming the housing from a metal material in the region of the fastening regions, torques acting on the housing in the region of the fastening can be absorbed by the material, in particular by the metal material, of the housing so that the forces occurring are no longer introduced into the fastening means accommodated in the fastening region. The housing is an outer housing of the charging socket, which outer housing delimits the charging socket to the outside.

The at least one fastening region can have at least one receiving opening for a fastening means. The fastening means can then be, for example, a screw which is guided through the respective receiving opening in order to fasten, in particular to screw, the housing to the body. A fastening region can have a plurality of receiving openings arranged at a distance from one another, so that the housing can be fastened to, in particular screwed onto, the body at several locations or points.

Furthermore, it is also possible for the at least one fastening region to have at least one thread and/or at least one welded-on bolt in addition to or as an alternative to the at least one receiving opening in order to fasten the housing to the body. The selection or variance of the fastening of the charging socket to the body of a motor vehicle can thereby be increased.

The housing can have, for example, at least one insert formed from the metal material and at least one housing part formed from a plastic material, wherein the at least one insert formed from the metal material can be connected to the at least one housing part formed from the plastic material. Due to the design in the form of an insert, the housing with its different materials can be produced in a simple manner. The insert makes a defined delimitation possible between the metal material and the plastic material of the housing. The at least one fastening region can be formed on the insert before the insert is connected to the at least one housing part formed from plastic material. The housing can have one or more housing parts, which can be formed from a plastic material. If the housing has, for example, two housing parts made of a plastic material, the insert can be arranged between these two housing parts. Two more inserts can also be provided, which can be connected to the at least one housing part.

The at least one insert can be connected to the at least one housing part in a force-fitting and/or form-fitting and/or bonded manner. For the force-fitting connection, the insert can be screwed to one or more housing parts. Furthermore, it is possible for the at least one housing part to have one or more grooves, into which the at least one insert engages, in particular is pressed, so that a form-fitting connection between the insert and one or more housing parts can be formed. The insert can also have one or more grooves, into which one or more housing parts can engage, in particular be pressed. Furthermore, the at least one insert can be glued to the at least one housing part in order to form a bonded connection between the at least one insert and the at least one housing part. The different types of fastening can also be combined with one another.

It can preferably be provided that the at least one housing part is injection-molded onto the at least one insert. During the injection-molding process for forming the at least one housing part, the at least one housing part can thus be injection-molded directly onto the at least one insert in order to be able to form a particularly stable and secure connection between the at least one insert and the at least one housing part. The injection molding enables a close-to-contour connection of the at least one insert to the at least one housing part. For this purpose, the at least one insert can be place in the injection mold and the at least one housing part can be injection-molded around the insert.

Preferably, the housing has two housing parts made of a plastic material, wherein the at least one insert can then be arranged between this first housing part and the second housing part. The insert and thus the metal material is then preferably provided along the length of the housing such that the insert just fails to form an end section along the length of the housing.

In order to reliably ensure the accessibility of the at least one fastening region even in an assembled state of the housing or the charging socket, the at least one insert can have a larger outer circumferential surface than the at least one housing part which is formed from a plastic material. The at least one insert can thus protrude outwards from the at least one housing part at least in regions, so that in the region of the at least one insert the size of the outer circumferential surface of the housing is determined by the outer circumferential surface of the at least one insert. The at least one insert then overlaps the at least one housing part of the housing at least in regions.

The at least one insert can be a punched/bent part, for example. By forming it as a punched/bent part, the insert can be easily manufactured, whereby the shape of the insert can be adapted individually. For example, the insert can be formed from a punched and bent piece of sheet metal. An offset between fastening regions or between receiving openings of one or more fastening regions can then be introduced, in particular punched, into the sheet metal part.

For example, the at least one insert can have a frame shape. The insert can thus extend over the entire circumference of the housing, wherein the insert then has a window-like opening, through which internal components of the charging socket, such as the at least one contact element, are guided.

Furthermore, it is also possible for the housing to be formed completely from a metal material. The housing then does not require an insert and also no further housing parts. If the housing is manufactured completely from a metal material, the entire housing of the charging socket will have a particularly high stability and strength. A contact holder of the charging socket, in which the at least one contact element of the charging socket is held, is formed from a plastic material so that a sufficient insulation between the at least one contact element and the housing is formed even when the housing is formed completely from a metal material.

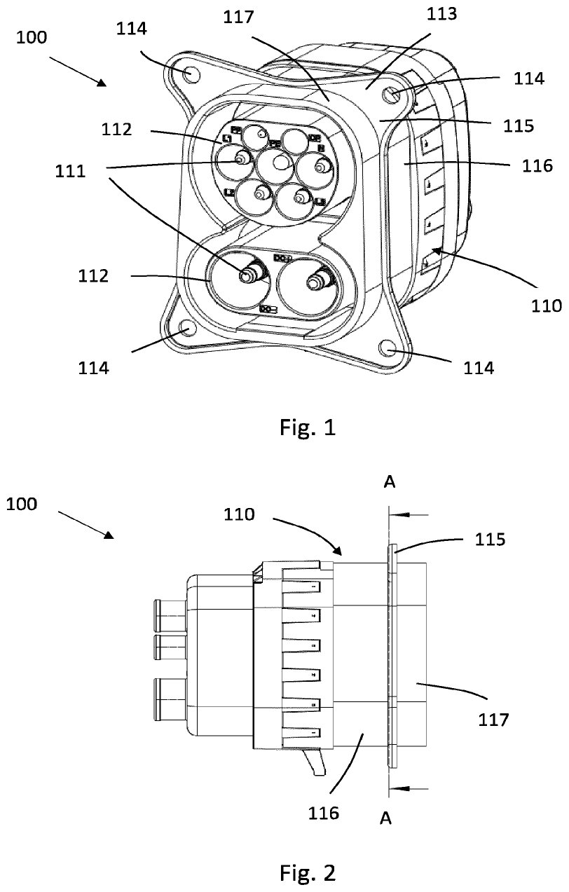

FIGS. 1 and 2 show a charging socket 100 which can be installed in an at least partially electrically driven motor vehicle by fastening the charging socket 100 to the body of the motor vehicle.

The charging socket 100 also comprises a housing 110. The housing 110 forms an outer housing of the charging socket 100. A plurality of contact elements 111 are arranged in the housing 110, which contact elements can be connected in an electrically contacting manner to contact elements formed on a charging plug when the charging plug is inserted into the charging socket. The contact elements 111 are held in a contact holder 112, wherein the contact holder is arranged in the housing 110 so that the housing 110 surrounds the contact holder 112. The contact holder 112 is formed from a metal.

A fastening region 113, via which the housing 110 and thus the charging socket 100 can be fastened to the body of a motor vehicle, is formed on the housing 110.

In the embodiment shown here, the fastening region 113 has four receiving openings 114 which are arranged at a distance from one another and through each of which a fastening means, such as a screw, can be guided in order to fasten the housing 110 to the body.

In the region of the fastening region 113, the housing 110 is formed from a metal material. The remaining region of the housing 110 is formed here from a plastic material. The housing 110 thus forms a hybrid component which is formed from a plastic material and a metal material.

To form the hybrid component part, the housing 110 has an insert 115 formed from the metal material and two housing parts 116, 117 formed from a plastic material. The insert 115 is arranged between the two housing parts 116, 117, as can be seen in particular in FIG. 2.

The insert 115 is formed here from a piece of sheet metal which has been punched and bent into the desired shape. The insert 115 thus has a lesser thickness than the two housing parts 116, 117. Alternatively, the insert 115 could also be a die-cast part.

FIG. 4 shows the insert 115 by itself. The insert 115 has a frame shape such that the insert 115 extends over the entire circumference of the housing 110. The insert 115 has a window-like opening 118, through which internal components of the charging socket 100, such as the contact elements 111 and the contact holder 112, are guided.

The four receiving openings 114 are formed on the four outer corners 119 of the insert 115. The outer corners 119 each project outwards.

In particular in the region of the outer corners 119, the insert 115 has a larger outer circumferential surface than the two housing parts 116, 117, so that, in particular with the four outer corners 119, the insert 115 projects beyond the two housing parts 116, 117 and protrudes outwards. The receiving openings 114 are thus easily accessible in the assembled state of the charging socket 100, so that the charging socket 100 can be fastened to the body of the motor vehicle without great effort.

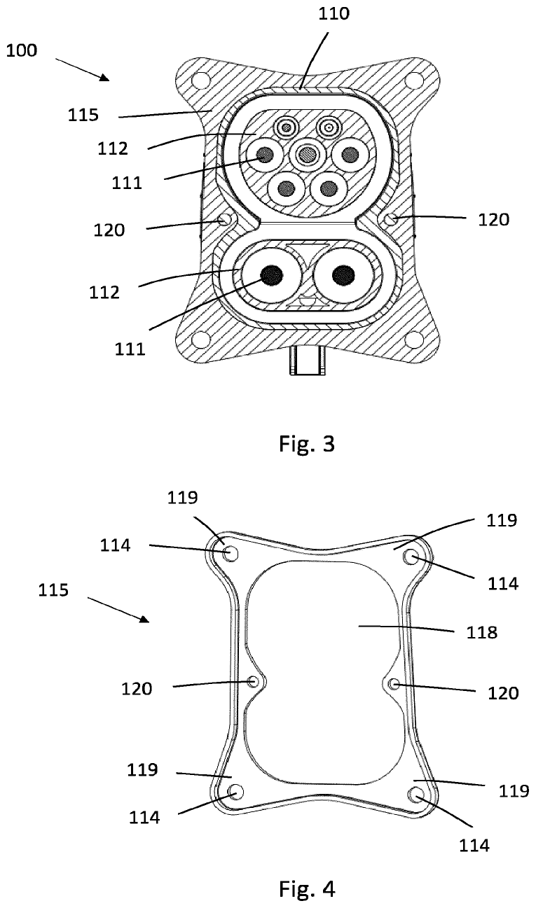

As can be seen in the sectional view of FIG. 3, the insert 115 is arranged overlapping the two housing parts 116, 117 at least in regions. The two housing parts 116, 117 can be injection-molded onto the insert 115. In the embodiment shown here, the insert 115 has two through-holes 120, through which the plastic material of the two housing parts 116, 117 passes during the injection molding of the two housing parts 116, 117, as can be seen in the sectional view of FIG. 3, as a result of which a particular secure and close-to-contour connection of the housing parts 116, 117 to the insert 115 is possible.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 Charging socket
110 Housing
111 Contact element
112 Contact holder
113 Fastening region
114 Receiving opening
115 Insert
116 Housing part
117 Housing part
118 Window-like opening
119 Outer corner
120 Through-hole

1. A charging socket for mounting in a body of an at least partially electrically driven motor vehicle, comprising:
a housing;
at least one contact element accommodated in the housing; and
at least one fastening region formed on the housing configured to fasten the charging socket to the body of the motor vehicle,
wherein the housing comprises a metal material at least in regions, and
wherein the housing comprises the metal material at least in a region of the at least one fastening region.

2. The charging socket of claim 1, wherein the at least one fastening region has at least one receiving opening for a fastening means.

3. The charging socket of claim 1, wherein the housing has at least one insert comprising the metal material and at least one housing part comprising a plastic material, and
wherein the at least one insert comprising the metal material is connected to the at least one housing part comprising the plastic material.

4. The charging socket of claim 3, wherein the at least one insert is connected to the at least one housing part in a force-fitting and/or form-fitting and/or bonded manner.

5. The charging socket of claim 4, wherein the at least one housing part is injection-molded onto the at least one insert.

6. The charging socket of claim 3, wherein the at least one insert is arranged between a first housing part and a second housing part.

7. The charging socket of claim 6, wherein the at least one insert has a larger outer circumferential surface than an outer circumferential surface of the at least one housing part.

8. The charging socket of claim 3, wherein the at least one insert comprises a punched and bent part.

9. The charging socket of claim 3, wherein the at least one insert has a frame shape.

10. The charging socket of claim 1, wherein the housing is entirely comprised of the metal material.
